(19) United States
(12) Patent Application Publication
(10) Pub. No.: US 2003/0017043 A1
(43) Pub. Date: Jan. 23, 2003

(54) Method and device for stacking flat articles

(75) Inventor: Walter Reist, Hinwil (CH)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(73) Assignee: Ferag AG, Hinwil (CH)

(21) Appl. No.: 10/196,801

(22) Filed: Jul. 17, 2002

(30) Foreign Application Priority Data
Jul. 18, 2001 (CH) 1334/01

(51) Int. Cl. B65G 57/11

(52) U.S. Cl. 414/789; 414/790.3; 414/794.4

(57) ABSTRACT

For stacking flat articles (2), a stacking shaft (10) comprising pushing means (11) for removing stacks from the shaft is used and for supplying the articles (2) into the stacking shaft (10) a supply support (12) is used. The supply support (12) is oriented towards the opening of the stacking shaft (10) at in inclination from above and the completed stacks (1) are pushed out in a direction opposite the supply direction. This makes it possible to resume the supply operation after an interruption necessary for the pushing-out, before the stack (1) is pushed out of the stacking shaft (10) completely. This results in very short cycle times. The stacking method is suitable in particular for stacking folded printed products being supplied in the supply stream parallel to their folded edges. The device is distinguished by its simplicity and by the fact, that it requires very little space.

### FIELD OF THE INVENTION

The invention is related to a method and a device for stacking flat articles, in particular for stacking printed products.

### BACKGROUND OF THE INVENTION

It is known to deposit printed products in a stacking shafts or in a similar device for the purpose of producing stacks of printed products. Such devices usually comprise a bottom and guide walls standing vertically on the bottom and they are open on the top for the supply of the printed products. In order to reduce to a minimum the free fall of the printed products during stacking, the position of the bottom or of the supply system is often adapted to the height of the stack already present in the shaft, so that every printed product can be slid substantially horizontally onto the previously deposited printed product or onto the shaft bottom.

For producing cross stacks, in which the printed products are stacked in layers or product groups each respectively rotated by 180° relative to one another, e.g. the bottom of the stacking shaft is designed for being rotated, and at least one intermediate bottom being removable from the shaft is provided. Whenever a product group has been deposited, the bottom with the groups already stacked on it is rotated by 180° while the printed products for the subsequent product group are being stacked on the intermediate bottom. When the bottom with the stack is again positioned after rotation, the intermediate bottom if so required is lowered into the stacking shaft and is then pulled out of the shaft such depositing the printed products stacked on it on the rotated stack.

When a stack is completed parts of the vertical guide walls or shaft walls are removed, if so required, and the stack is pushed out of the stacking shaft, usually transverse to the supply direction (or transverse to its projection onto the plane of the stacking shaft bottom respectively) or in the supply direction. During the whole pushing-out process, the supply has to be interrupted or printed products being supplied have to be pre-stacked on an intermediate bottom.

In many cases, the supply stream is split-up such supplying two stacking shafts: printed products being supplied to one shaft, while a finished stack is being pushed out of the other stacking shaft.

From the above brief description of the stacking processes as known in the printing field, it is evident, that for their implementation in particular with high performance capacities or with short cycle times respectively, rather elaborate devices are necessary, devices which in addition require a lot of space.

### BRIEF DESCRIPTION OF THE INVENTION

It is the object of the invention to create a method for stacking flat articles, the method allowing implementation with very simple devices and little space but still allowing high unit processing capacities. It is a further object of the invention to create a device for carrying out the method according to the invention.

In accordance with the invention, the flat articles are supplied to the stacking shaft lying loosely on a supply support or else held clamped between two supply supports e.g. in an imbricated formation with the leading edges positioned on the top of the formation. The supply support is e.g. a conveyor belt and it brings the articles at an inclination from above towards a supply side of the stacking shaft and advantageously to right above the stacking shaft, where the supply support ends. The flat articles are driven by the supply support beyond the end thereof and against the side of the stacking shaft opposite the supply side, and they fall from the supply support into the stacking shaft at the latest, when their leading edge has reached this opposite side.

The completed stacks are pushed out in a pushing-out direction opposite to the supply direction (pushing-out direction opposite to the projection of the supply direction onto the plane of the stacking shaft bottom), i.e. through the supply side of the stacking shaft. For the pushing operation e.g. a per se known pusher is used, its pushing movement starting at the side opposite the supply side of the stacking shaft and being directed towards the supply side. For returning the pusher back to its starting position, it is moved outside of the stacking shaft, for example, underneath the stacking shaft or besides the stacking shaft.

The article supply is interrupted for a first part of the pushing movement. However, the supply can be resumed, as soon as the trailing side of the pushed stack has passed the one point in the stacking shaft, at which a further supplied article comes into contact with the stack to be pushed out, i.e., at which this article would come into conflict with the stack. The article supply does not have to be interrupted for at least as long as the complete pushing operation takes as is necessary with known stacking methods; only a fraction of this time is sufficient. Therefore, stacking with the method according to the invention allows shorter cycle times or a higher capacity respectively and/or it allows shorter supply interruptions or less buffered articles respectively which means easier handling than is the case with known stacking methods.

The supply interruption necessary for the pushing-out becomes shorter, the more steeply from above supply takes place and the longer a free fall into the stacking shaft, i.e. a fall not guided by the supply support, can be tolerated. Because articles having a greater inherent stiffness can be stacked still well after a longer free fall than more flexible articles, the method in accordance with the invention is particularly adapted for stacking stiffer articles. If the method according to the invention is used for folded printed products, these are advantageously supplied to the stacking shaft in parallel with their folded edge (i.e., for tabloid newspapers with a single fold or for newspapers folded twice: in longitudinal direction), because these products have a significantly greater stiffness parallel to the folded edge than transverse to it. Such supply provides the further advantage, that pushing-out of the stack is directed also parallel to the folded edge, i.e. in the one direction, in which stack stability for folded printed product stacks is greatest.

The method in accordance with the invention is therefore suitable in particular for stacking folded printed products, wherein these are supplied parallel to their folded edges and the stack is pushed out in the opposite direction, once again parallel to the folded edges. For producing cross stacks, the printed products advantageously are supplied in an imbricated stream with alternating groups of correspondingly oriented products, wherein for supply interruptions the imbricated stream comprises gaps or the printed products are temporarily stopped or dammed.

The device for carrying out the method according to the invention comprises a stacking shaft and a supply support leading from above at an incline towards the supply side of the stacking shaft and ending above the opening of the stacking shaft (directly at the supply side or between the supply side and the opposite side). Furthermore, there is a pushing means being movable through the stacking shaft in a pushing direction opposite the supply direction and being returnable into its starting position on the side of the stacking shaft opposite the supply side not through the stacking shaft. If so required, the device also comprises a means for interrupting the supply stream of flat articles.

### BRIEF DESCRIPTION OF THE FIGURES

Method and device in accordance with the invention are now described in detail on the basis of the following Figs. wherein:

FIGS. 1 to 3 show successive phases of the stacking method according to the invention;

FIGS. 4 and 5 show two schematic diagrams illustrating the association between the duration of the supply interruption, the supply angle and the free fall of the articles to be stacked in the stacking shaft;

FIGS. 6 and 7 show two exemplary embodiments of the device in according to the invention.

### DETAILED DESCRIPTION OF THE INVENTION

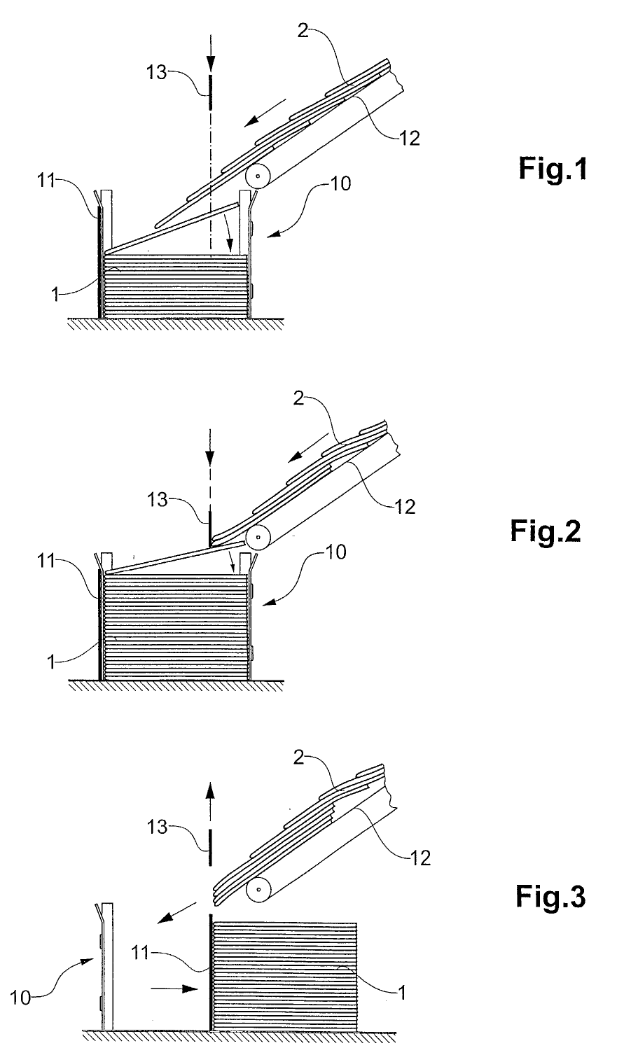

FIGS. 1 to 3 illustrate successive phases of the process of stacking flat articles 2 in stacks 1 using the method according to the invention. The Figs. each respectively depict a stacking shaft 10 with a pushing means 11, with a supply support 12 (conveyor belt) leading at an incline from above towards the supply side of the stacking shaft 10, and with a means 13 for interrupting the supply stream during a first part of the process of pushing-out a completed stack from the stacking shaft.

FIG. 1 illustrates a growing stack 1. At the moment depicted, the leading edges of supplied articles are making contact with the side of the stacking shaft opposite the supply side, immediately above the stack surface, while the trailing edge at the latest at this point in time is leaving the end of the supply support 12. This means, that for the final positioning of the article the leading edge is not displaced on the stack anymore. The free-fall of the flat article is guided by the already positioned leading edge. For articles, which have been deposited on the stack before the moment in time illustrated in FIG. 1, the free-fall is longer and also affects the leading edge.

FIG. 2 illustrates the depositing of the last article 2 on the stack 1. From this Fig. it is evident, that the end of the supply support, at least at this point in time, has to have a position, which makes it possible for the trailing edge of this last article also to be separated from the supply support 12 for being able to fall onto stack 1.

While the last article is being positioned on the stack, supply of articles is interrupted, for example, by introducing a damming means 13 into the supply stream of the articles 2. The illustrated damming means 13 is positioned immediately above the stacking shaft 10. It goes without saying, that it may also be effective further upstream.

FIG. 3 depicts the pushing-out of the completed stack 1, which is illustrated after having passed the position which allows restart of the supply of articles 2. Obviously, the remainder of the pushing movement can be carried out, without articles 2 continuing to be fed-in coming into conflict with the stack 1 being pushed out.

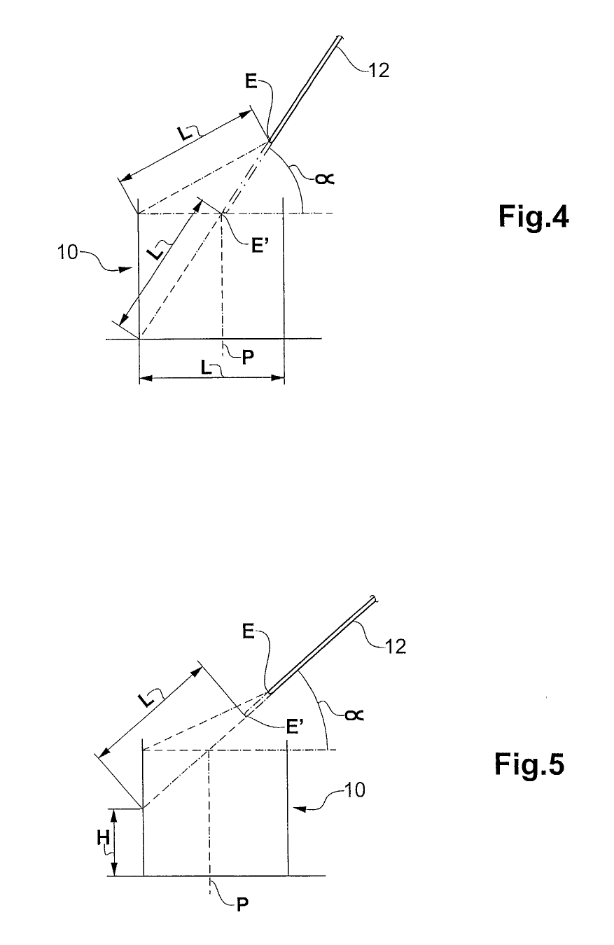

FIGS. 4 and 5 illustrate the association between the orientation and the position of the supply support 12, the stacking process and the pushing-out process. The same parts are designated with the same reference numbers as in the FIGS. 1 to 3.

The supply support 12 in FIG. 4 forms a supply angle α with the bottom of the stacking shaft 10 and is positioned in such a manner, that the leading edge of a first article to be stacked (not illustrated) makes contact with the side of the stacking shaft situated opposite the supply side just above the stack shaft bottom. Already in the case of this first article therefore, the free-fall does not affect the leading edge, which is an advantage for a controlled stacking operation.

From FIG. 4 it is clearly evident, that the position P to be passed by a pushed stack before restart of article supply is displaced towards the side of the stacking shaft 10 opposite the supply side when the angle α is increased. This also leads to shorter supply interruptions being necessary for the pushing operation.

The position of the end E of the supply support 12 is defined in such a manner by the length L and the stiffness of the flat articles, that the trailing edge of the last article of a stack is able to fall off this end. Therefore, the distance between the trailing, upper edge of the stack and the end E of the supply support 12 has to be of at least the same size as the length of the articles in the supply direction; this being applicable at least in the case of stiff articles. In the case of flexible flat articles, the named distance can be smaller. For an optimally guided article supply, the end of the supply support 12 can be designed for moving during stacking from a starting position E′ closer to the stacking shaft 10 into the end position E as defined above.

FIG. 5 demonstrates, that the position P can be displaced further towards the side of the stacking shaft 10 opposite the supply side, i.e. the interruption of article supply being necessary for the pushing operation can be shortened further, if the supply direction is not oriented towards the stacking shaft bottom, as is illustrated in FIG. 4, but rather contacts the side of the stacking shaft 10 opposite the supply side at a height H above the stacking shaft bottom. This, however, signifies, that for the first articles supplied to the stacking shaft (up to a stacking height, which is equivalent to H), the leading edges are only definitively positioned following a free-fall.

Because various characteristics of the flat articles to be stacked influence the stacking operation, for every type of article to be stacked the optimum parameters α and H have to be determined.

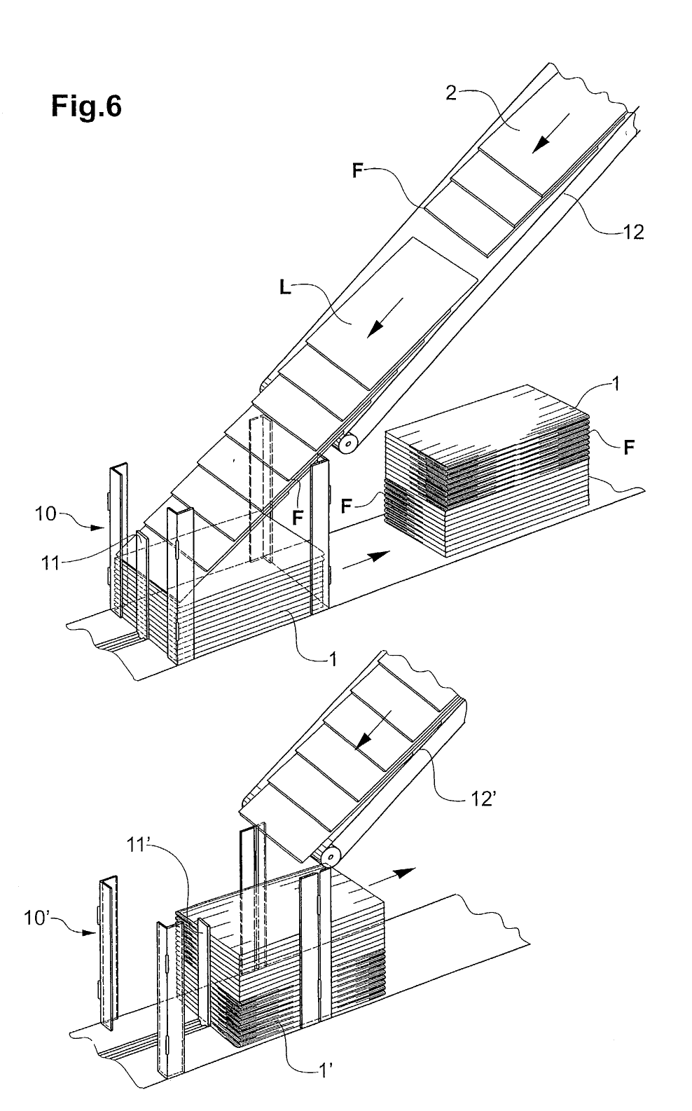

FIG. 6 depicts in a three-dimensional illustration an exemplary embodiment of the device in accordance with the invention. The Fig. illustrates two stacking shafts 10 and 10′ arranged one above the other, each respectively with a supply support 12 and 12′ for supply streams of articles 2 to be stacked. The articles 2 are folded printed products with folded edges F. The printed products are positioned in the illustrated supply streams in alternating groups rotated relative to one another by 180°. The stream also comprises gaps L, which are sufficiently large for constituting supply interruptions for the pushing operation and which if so required are made use of for the pushing operation. Between two gaps, several product groups can follow without any gaps in such a manner, that at every gap a completed stack is pushed out. The stacks 1 and 1′ being established are cross stacks.

FIG. 6 illustrates the particularly advantageous application of the method and the device in accordance with the invention for stacking printed products, which are supplied in a supply stream parallel to their folded edges F and already oriented for being stacked cross-wise. It demonstrates how simple and how space-saving the device according to the invention is. One skilled in the art knows applicable methods for establishing a supply stream comprising the printed products in groups being rotated by 180° relative to one another and further comprising gaps. A preferred method of this kind is the subject of a parallel application to the present patent application.

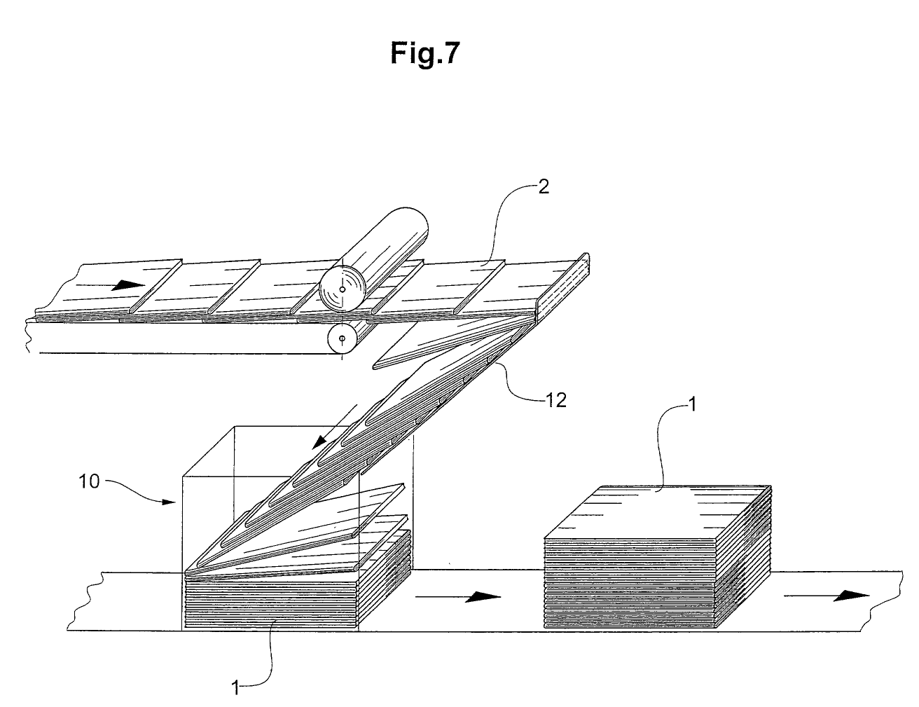

FIG. 7 very schematically illustrates a further exemplary embodiment of the device in accordance with the invention. The supply stream of the flat articles 2 to be stacked is first directed parallel to the pushing-out direction. Then, in a zone above the stacking shaft 10, the articles 2 fall onto the supply support 12 which conveys them onwards in the opposite direction and supplies them to the stacking shaft. Here too, the great simplicity of the device and the space-saving arrangement are striking.

1. Method for producing stacks (1) of flat articles (2), comprising the steps of supplying the articles (2) to a stacking shaft (10) in a supply stream being oriented towards the stacking shaft (10) at an incline from above, stacking the supplied flat articles in the stacking shaft (10) and pushing the stacks (1) out of the stacking shaft (10) in a direction opposite to the direction of the supply stream.

2. Method in accordance with claim 1, wherein during a first part of the pushing operation no articles (2) are supplied to the stacking shaft (10) and wherein the article supply for a next stack (1) is started before the stack (1) has been pushed out completely.

3. Method according to claim 1, wherein the supply stream is an imbricated stream.

4. Method in accordance with claim 1, wherein the supply stream comprises gaps (L).

5. Method according to claim 1, wherein the articles (2) in the supply stream are dammed during the first part of the pushing operation.

6. Method in accordance with claim 1, wherein the flat articles (2) are folded printed products.

7. Method according to claim 6, wherein the printed products in the supply stream are conveyed parallel to their folded edge (F) and the stacks (1) are pushed out parallel to the folded edges (F).

8. Method in accordance with claim 7, wherein the printed products in the supply stream are arranged in groups being rotated relative to one another by 180°.

9. Device for producing stacks (1) of flat articles (2), the device comprising a stacking shaft (10), a pushing means (11) and a supply support (12), wherein the supply support (12) is oriented towards a supply side of the stacking shaft (10) at an inclination from above and the pushing means (11) is movable from a starting position on the stacking shaft side situated opposite the supply side through the stacking shaft (10) to the supply side and is returnable outside the stacking shaft (10) back into the starting position.

10. Device in accordance with claim 9, wherein the end (E) of the supply support (12) is arranged above the stacking shaft (10).

11. Device according to claim 9, wherein the end (E) of the supply support (12) is displaceable during stacking.

12. Device in accordance with claim 9, wherein it further comprises a means (13) for damming the articles (2) in the supply stream.
